(19) United States
(12) Patent Application Publication
(10) Pub. No.: US 2025/0247356 A1
(43) Pub. Date: Jul. 31, 2025

(54) Network Transaction Identifier Uniquification

(71) Applicant: Arm Limited, Cambridge (GB)

(72) Inventors: David Yue Williams, Austin, TX (US); Wenjin Lu, Austin, TX (US); Premkishore Shivakumar, Austin, TX (US); David Frederick Greenberg, Austin, TX (US); Rohit Pandharinath Pawar, Austin, TX (US); David Allen Brown, Austin, TX (US)

(73) Assignee: Arm Limited, Cambridge (GB)

(21) Appl. No.: 18/424,083

(22) Filed: Jan. 26, 2024

(51) Int. Cl. H04L 61/00; H04L 61/2596; H04L 69/18

(52) U.S. Cl. CPC H04L 61/35; H04L 61/2596; H04L 69/18

(57) ABSTRACT

A network interface is configured to receive incoming requests with a common incoming transaction identifier from a manager device of a data processing network. Each incoming request is associated with an address in the data processing network. The interface generates an outgoing transaction identifier based on the address and the common incoming transaction identifier and sends an outgoing request, with the outgoing transaction identifier, to a target device in the data processing network. The outgoing transaction identifiers generated from different addresses differ from one another and may be generated using a hash circuit. The interface forwards responses to ordered incoming requests to the manager device in the same order as the incoming requests were received.

### BACKGROUND

In a data processing network, a message may contain a transaction identifier field that holds a transaction identifier (ID). When a series of ordered requests are issued from a manager device of the network (i.e., requests to be serviced in order), the messages contain a common transaction identifier (ID). A common transaction identifier is also used in other transactions such as exclusive writes and atomic operation. However, some subordinate devices (such as memory controllers) connected to the output endpoints of the network interconnect fabric may perform better when presented with access requests having different identifiers (IDs) as opposed to access requests having a common ID.

A network interconnect can generate an outgoing transaction ID by adding bits to an incoming transaction ID to identify the manager device that issued a request. As networks become larger, with cascading interconnects or hierarchical structures, the size (bit-width) of the ID may grow too large for a subordinate device to support.

### BRIEF DESCRIPTION OF THE DRAWINGS

The accompanying drawings provide visual representations which will be used to describe various representative embodiments more fully and can be used by those skilled in the art to understand better the representative embodiments disclosed and their inherent advantages. In these drawings, like reference numerals identify corresponding or analogous elements.

FIG. 1 is a block diagram of a data processing network, in accordance with various representative embodiments.

FIG. 2 is a signal flow chart, in accordance with various representative embodiments.

FIG. 3 is a diagrammatic representation of information flow between a manager device and a subordinate network via a subordinate network interface (SNI), in accordance with various representative embodiments.

FIG. 4 is a diagrammatic representation of outgoing transaction identifier generation using a hash function, in accordance with various representative embodiments.

FIG. 5 is a diagrammatic representation of an entry in a tracker table, in accordance with various representative embodiments.

FIG. 6 is a flow chart of a method of updating a tracker table of an SNI, in accordance with various representative embodiments.

FIG. 7 is a flow chart of a method of processing incoming responses to an SNI, in accordance with various representative embodiments.

FIG. 8 is a block diagram of a circuit configured to process Ordered Write Observations (OWOs), in accordance with various representative embodiments.

FIG. 9 is a flow chart of a method of handling Ordered Write Observations (OWOs), in accordance with various representative embodiments.

### DETAILED DESCRIPTION

The various apparatus and devices described herein provide mechanisms for converting transaction identifiers (IDs) in a data processing network. In one embodiment, incoming messages to a network interface having the same incoming transaction ID but different addresses are used to generate outgoing messages with different outgoing transaction IDs. Herein, the ID is said to be “diversified” by the interface.

While this present disclosure is susceptible of embodiment in many different forms, there is shown in the drawings and will herein be described in detail specific embodiments, with the understanding that the embodiments shown and described herein should be considered as providing examples of the principles of the present disclosure and are not intended to limit the present disclosure to the specific embodiments shown and described. In the description below, like reference numerals are used to describe the same, similar or corresponding parts in the several views of the drawings. For simplicity and clarity of illustration, reference numerals may be repeated among the figures to indicate corresponding or analogous elements.

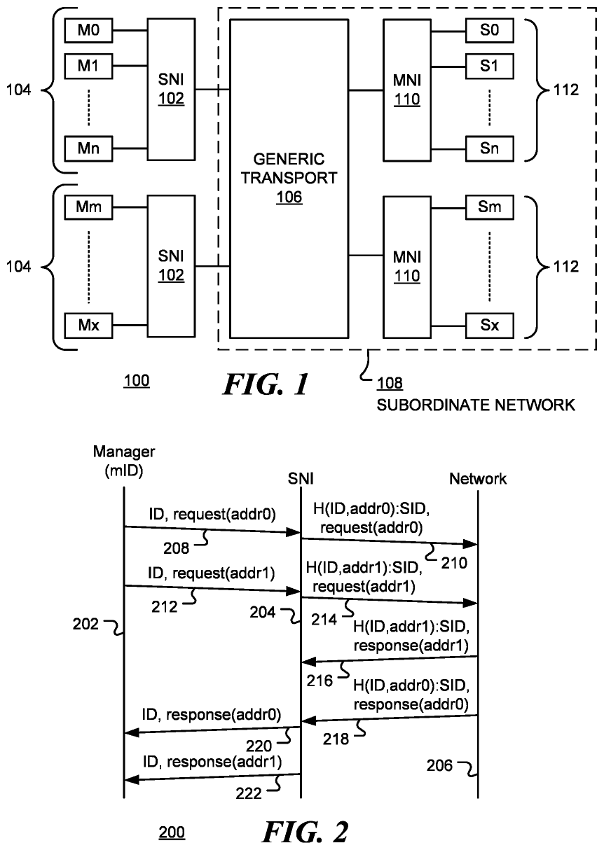

FIG. 1 is a block diagram of a data processing network 100, in accordance with various representative embodiments. One or more subordinate network interfaces (SNIs) 102 couple manager devices 104 to interconnect fabric 106 of subordinate network 108. Interconnect fabric 106 is coupled via one or more manager network interfaces (MNIs) 110 to one or more subordinate devices 112. A manager device may be a processor, for example. An SNI may be, for example, an AXI SNI (ASNI) coupled to a manager device via bus configured according to the Arm® AMBA® AXI protocol of Arm Limited. An SNI may be an HNSI, coupled to a manager device, such as a processor, via bus configured according to the Arm® AMBA® AHB protocol of Arm Limited Arm®. Other bus protocols may be used without departing from the present disclosure. Different interfaces in the same network may use different protocols to enable connection to various device types. An MNI may be an XMNI, HMNI or PMNI, coupled to subordinate devices via an AMBA® AXI bus, AMBA® AHB bus or AMBA® APB bus, respectively. Again, other bus protocols may be used without departing from the present disclosure. A subordinate device may be a memory controller, for example.

In one embodiment, ASNIs convert AXI and ACE-Lite transactions into Generic Transport (GT) packets for transmission though generic transport interconnect fabric 106. AMNIs convert packets from GT packets to AXI or ACE-Lite protocol transactions. HSNIs convert AHB5 and AHB-Lite transactions into GT packets. HMNIs convert packets from the GT packets to AHB5 or AHB-Lite protocol transactions. PMNIs convert GT packets to APB protocol transactions.

A protocol, such as AMBA® AXI for example, may specify the use of transaction identifiers (IDs). A transaction request includes a transaction ID that is used to identify the transaction from a given requester. As a requester, a manager device can use these to identify separate transactions that must be returned in order. All transactions with the same ID value should remain ordered, but there is no restriction on the ordering of transactions with different ID values. This means that a single physical port can support out-of-order transactions by acting as a number of logical ports, each of which handles its transactions in order. By using transaction IDs, a manager device can issue transactions without waiting for earlier transactions to be completed. This can improve system performance because it enables parallel processing of transactions.

An embodiment of the disclosure relates to a mechanism for converting incoming transaction identifiers (IDs) at a network interface to outgoing transaction IDs. In a transaction-based protocol, such as the AMBA® AXI protocol, message traffic with a common transaction ID is converted into outgoing traffic with multiple IDs. The mechanism handles edge cases such as atomic operations, persistence, exclusive operations, unique IDs, device transactions (versus normal transactions), and ordered-write observation, and does so in a way that optimizes performance and power efficiency. In addition, some embodiments of the mechanism remove the need for a content addressable memory (CAM) on transaction request processing through intelligent selection of hash fields to generate IDs and remove the need for a CAM on response processing by sending a tracker table index as meta-data. Other embodiments may use a CAM for transaction request processing and not use meta-data.

A method of operation of a network interface is disclosed. A representative embodiment of the method includes receiving incoming requests at an interface of a data processing network from a manager device operably coupled the interface, the incoming requests having a common incoming transaction identifier and each incoming request associated with an address in the data processing network. For each incoming request of the incoming requests, an outgoing transaction identifier is generated based on the address and the common incoming transaction identifier and an outgoing request is sent to a target device in the data processing network, the outgoing request having the outgoing transaction identifier. The outgoing transaction identifiers generated from different addresses differ from one another.

Generating the outgoing transaction identifier based on the address associated with the incoming request and the common incoming transaction identifier may include masking or truncating the address to produce a modified address, combining the modified address and the common incoming transaction identifier to produce a hash argument, and generating a hash value of the hash argument as the outgoing transaction identifier.

Combining the modified address and the common incoming transaction identifier to form a hash argument may include expanding the common incoming transaction identifier to the bit-width of the modified address and generating the hash argument as a bitwise logical combination of the expanded common incoming transaction identifier and the modified address.

When the plurality of incoming requests are ordered, the responses to the outgoing requests are ordered at the interface before forwarding to the requesting device.

For each incoming request, an entry for the incoming request is stored at a location in a tracker table and the index of the entry in tracker table is included in the outgoing request corresponding to the incoming request. The index is also included in the response to the outgoing request, enabling the corresponding entry in the tracker table to be accessed. The response is processed in accordance with the accessed tracker table entry. In particular, responses are ordered in accordance with the order of the incoming requests.

Since the outgoing transaction identifiers are based on the incoming transaction ID and the address, read and write requests with the same incoming transaction ID for the same address have the same outgoing transaction ID.

In various embodiments, the network interface converts the incoming request from a first protocol to provide the outgoing request in a second protocol.

Exclusive read and write requests may be downgraded to normal read and write requests when ordered write observations are enabled in the network. For exclusive write requests, the incoming transaction identifier may be included in the outgoing transaction identifier when ordered write observations are enabled.

Various embodiments relate to a network interface configured to receive incoming requests from a manager device of a data processing network, the incoming requests having a common incoming transaction identifier and each incoming request associated with an address in the data processing network. For each incoming request of the plurality of incoming requests an outgoing transaction identifier is generated based on the address and the common incoming transaction identifier and an outgoing request, including the outgoing transaction identifier, is sent to a target device in the data processing network. Outgoing transaction identifiers generated from different addresses differ from one another.

The network interface may include a logic circuit configured to perform a bitwise combination of the address and the incoming transaction identifier, producing a hash argument, and a hash circuit configured to generate a hash of the hash argument as at least a portion of an outgoing transaction identifier.

The network interface may also include:
an address modification circuit configured to mask or truncate the address to provide a modified address with n-bits, where n is an integer;
an identifier expanding circuit configured to expand the incoming transaction identifier to n-bits to provide an expanded identifier;
a logic circuit configured to perform a bitwise combination of the modified address and the expanded identifier, producing a hash argument; and
a hash circuit configured to generate a hash of the hash argument as at least a portion of an outgoing transaction identifier.

The network interface may also include a tracker table for recording an order of incoming requests and a re-order buffer (ROB) for storing out-of-order responses to outgoing requests.

The network interface may also include configuration registers, where operation of the ID diversifier circuit is controlled by values stored in the configuration registers.

Computer-readable code for fabrication of a network interface may be stored on a non-transitory computer-readable medium. In one embodiment, the code describes a network interface configured to receive incoming requests from a manager device of a data processing network. Incoming requests may be associated with different addresses in the data processing network but may have a common incoming transaction identifier, in which case, for each incoming request, the network interface generates an outgoing transaction identifier based on the address and the common incoming transaction identifier. This is done in an identification (ID) diversifier circuit of the interface. The outgoing requests, sent to target devices in the network, include outgoing transaction identifiers which differ from one another.

Code for fabrication of the ID diversifier circuit, may be configurable to adjust a size of the outgoing transaction identifiers in a fabricated network interface.

The ID conversion mechanism, described in more detail below, provides configurability with respect to avoiding hash collisions. For example, a wider outgoing ID field can be specified to reduce the probability of hash collisions. Configurability may be provided prior to fabrication using configurable register transfer language code. Configurability may also be provided during operation via user configuration registers.

The conversion mechanism enables ID space reduction, reducing the problems duc to ID space expansion. The mechanism can be used to limit, or even reduce, ID space expansion by specifying a narrower hash output.

In one embodiment, diversified IDs are generated using a hash function that takes, as input, a combination of the incoming transaction ID and the address associated with an incoming message. The amount of address used in the hash may be determined using a configuration register and may be based on data organization such as the split size of the region addressed. The address may be reduced by masking. The size of the hash output may be user configurable to reduce the chance of collisions, where different hash inputs result in the same hash output.

In one embodiment, the input to the hash is selected to meet ordering requirements.

By including the address in the hash, accesses to the same address from the same incoming transaction ID result in the same outgoing hash, which will maintain the order of read requests to the same address. This is important for ordering rules that require that newer reads can return newer data than older reads but should not return older data than older reads.

The width of the outgoing transaction ID can be set such that an ID width reduction occurs.

FIG. 2 shows a signal flow chart 200, in accordance with various embodiments of the disclosure. The signal flow chart shows timeline 202 for a manager device, timeline 204 for a subordinate network interface (SNI) and timeline 206 for a subordinate network. Time flows in a downward direction in the chart. The SNI receives a first incoming request 208 from a manager device. The incoming request is associated with an address (denoted as “addr0” in this example) and has a transaction identifier (ID). The SNI transforms the incoming transaction ID into an outgoing transaction ID according to a function or mapping H. The outgoing transaction ID is also dependent on the address, addr0, associated with the request and is denoted by H (ID, addr0). The SNI generates an outgoing request 210 that includes the outgoing transaction ID and sends it to the subordinate network. Outgoing request 210 may also include an identifier, SID, of the SNI to enable routing of responses to the request. The manager ID, SID, may be concatenated with the outgoing transaction ID or included in a header. The outgoing transaction ID is said to be “diversified” in that incoming messages with a common ID result in outgoing messages with different IDs. As will be described in more detail below, the outgoing transaction ID may be created based on a configurable and optimized hash function that acts on a combination of the incoming transaction ID and an address associated with the incoming message. Selected ID bits can be masked from the hash depending on a configuration register and the number of address bits chosen for hash function input may depend on the stripe size of the region addressed. In one embodiment, the lower bits of the address, e.g., the lower 6-bits, are ignored. The burst split granularity for a given request determines if additional address bits are ignored, e.g. if burst split granularity is 256 bytes, then the lower 8 bits of address may be ignored for that request.

Additional address bits can be masked from the hash depending on contents of a configuration register.

In the example shown in FIG. 2, the manager device sends a second request 212 to the SNI. The second request has the same ID as the first request 208, but is for a different address, addr1. The common ID indicates the requests are ordered. The SNI generates an outgoing transaction ID for the second request and sends outgoing request 214 to the subordinate network. Since address addr1 is different from addr0, H (ID,addr0) is generally different from H (ID,addr1). Thus, incoming requests with the same ID result in outgoing requests with different IDs.

In the example shown, responses to outgoing requests 210 and 214 are received at the SNI out of order, as responses 216 and 218. In accordance with the present disclosure, the SNI reorders the incoming responses and generates in-order outgoing responses, 220 and 222, to the manager device. The manager device sends a request for addr0 followed by a request for addr1 and receives a response for addr0 followed by a response for addr1.

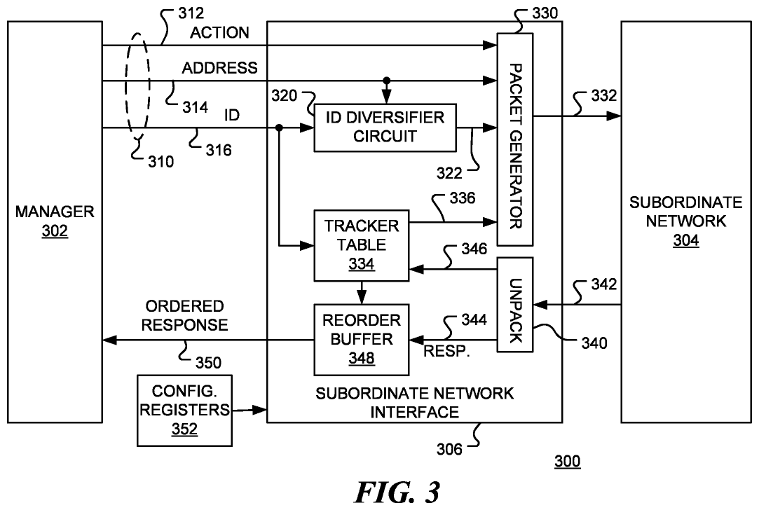

FIG. 3 is a diagrammatic representation 300 of information flow between manager device 302 and subordinate network 304 via SNI 306, in accordance with various representative embodiments. Manager device 302 sends request 310 to SNI 306. This may be sent over an AXI signal channel, for example. Request 310 specifies action 312 (such as a read or write operation), address 314 and incoming transaction ID 316. Requests may be sent over one or more channels. The request may contain additional information omitted here for clarity. Address 314 and incoming transaction ID 316 are input to ID diversifier circuit 320 to produce outgoing transaction ID 322. Outgoing transaction ID 322, together with the action 312 and address 314 are provided to packet generator 330 to generate an outgoing request packet 332 that is sent to subordinate network 304. In addition, ID 316 is used to generate an entry to tracker table 334 to enable responses to be reordered when needed. An index 336 to the tracker table entry may be provided to packet generator 330 for inclusion in outgoing request packet 332.

Unpack logic circuit 340 receives response packet 342 from subordinate network 304 and extracts response 344 and tracker table index 346. A response packet may be received from the interconnect fabric of the subordinate network in multiple data beats. Tracker table index 346 is used to access tracker table 334 to retrieve ordering information. When response 344 is received out of order, as determined from the ordering information, the response is stored in order buffer 348. When the response corresponds to the oldest request of a sequence, the ordered response 350 is forwarded to the manager device. Additional information is retrieved from the tracker table to determine if any other responses in the reorder buffer can also be sent in the specified order. Operation of an example tracker table is discussed in more detail below.

SNI 306 may be configured based on values stored in configuration registers 352. The configuration registers may specify, for example, the size of the outgoing transaction ID, and the number of address bit to be used in ID diversifier 320.

In accordance with various embodiments of the present disclosure, a diversified outgoing transaction ID is created using a hashing function based on an incoming transaction ID in an incoming message and an address. Selected bits of the incoming transaction ID can be masked from the hash depending on a configuration register. In addition, the number of address bits chosen for the hash can be selected dependent upon the stripe size of the region addressed. For example, the lower 6 bits of the address can be ignored. The burst split granularity for a given request can be used to determine if additional address bits are ignored. E.g., if the burst split granularity is 256 bytes, then the lower 8 bits of address may be ignored for that request. Additional address bits can be masked from the hash depending on configuration register values.

In one embodiment, the minimum ID space of the outgoing transaction ID is based on the maximum tracker depth (read or write tracker) across all interfaces. For example, if one interface has a maximum tracker depth of 256 and another interface has a maximum tracker depth of 128, then the outgoing transaction ID is 8 bits wide (or 9 bits including a bit indicating the ID has been diversified). A configuration parameter may be selected to override the minimum ID space with a larger value. Increasing the number of bits in the hash output reduces the probability of hash collisions.

Some architectures differentiate between normal memory and device memory. In one embodiment, requests to normal memory use a hash function of the incoming transaction ID and address, while requests to device memory use a hash function of incoming transaction ID only.

Normal memory is the default memory type for most applications and data. It supports caching, buffering, and reordering of memory accesses, which can improve performance and reduce power consumption. However, it also requires coherence management, which ensures that multiple processors or devices see the same view of memory. Coherence management can be done by hardware or software, depending on the system configuration and the memory attributes. Normal memory can have different levels of cacheability and shareability, which determine how often and with whom the memory contents are updated.

Device memory, in contrast, is a special memory type for accessing memory-mapped peripherals or devices. It does not support caching, buffering, or reordering of memory accesses, which can avoid data corruption or inconsistency. However, it may require strict ordering and synchronization of memory accesses, which can reduce performance and increase power consumption. Device memory can have different types of ordering and synchronization, which determine how the memory accesses are executed and observed.

A variety of hash functions may be used, and users or designers can select their own custom hash function.

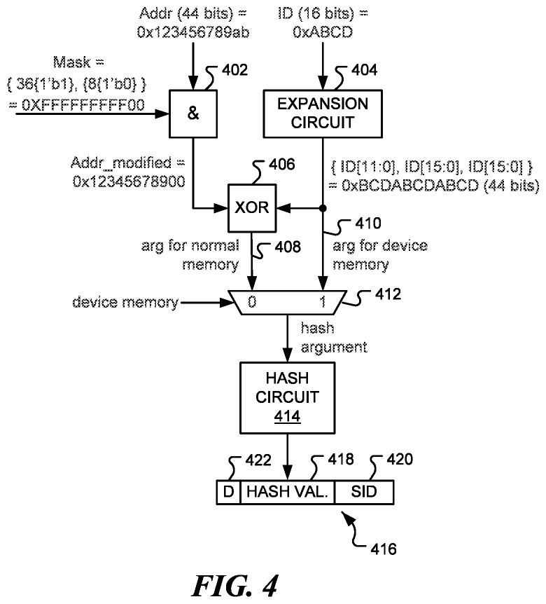

FIG. 4 is a diagrammatic representation of an example outgoing transaction ID generation using a hash function, in accordance with various representative embodiments. Logic circuit 402 produces a bitwise logical AND of the 44-bit incoming address Addr=0x123456789ab and a mask. In this example, the burst split granularity for the request is 256 bytes, so the lower 8 address bits are masked to produce the modified address:
addr_modified [43:0]=Addr [43:0]& 0xFFFFFFFFF00=0x12345678900.

In the above, Addr [43:0] denotes bits 0 to 43 of the address. In an alternative embodiment, the address is truncated to produce the modified address:
addr_modified [35:0]=Addr [43:8]=0x123456789.

The incoming transaction ID is 0xABCD. This is expanded to the same width as the masked address in expansion circuit 404. For example, in the case of address masking, the ID may be repeated to produce:
ID_expanded [43:0]={ID [11:0],ID [15:0],ID [15:0]}=0xBCDABCDABCD.

Other expansions may be used. For a request to normal memory, the input to hash function circuit (the argument of the hash function) is computed in logic circuit 406 to give output 408 as:
hash_arg_normal [43:0]=(addr_modified [43:0]\hat{ }ID_expanded), where “\hat{ }” denotes an XOR (exclusive or) bitwise logical operation. For a request to device memory, the argument of the hash function is the expanded ID 410
   hash_arg_device [43:0]=ID_expanded.

Switch 412 selects the input to hash circuit 414 based on the memory type. Thus, the outgoing diversified ID 416 includes hash value 418, given by H (hash_arg_normal) or H (hash_arg_device), respectively, where H denotes the selected hash function implemented in hash circuit 414. The outgoing diversified ID 416 may be concatenated with the SNI ID (SID) 420. Optionally, bit 422 may be set to indicate that the ID has been diversified. In some situations, discussed below, the incoming transaction ID is used in the outgoing transaction ID, in which bit 422 is cleared.

For normal memory, incoming messages with the same incoming transaction ID but different masked addresses generally result in different outgoing transaction IDs, thus the ID is “diversified.” Hash collisions may occur, in which different hash arguments produce the same hash output. However, such collisions only result in results being unnecessarily ordered. The probability of a collision may be reduced by increasing the width of the hash output.

A diversified outgoing transaction ID may be generated by other means. For example, a hash of the address may be combined with the incoming transaction ID or with a hash of the incoming transaction ID.

The disclosed mechanism provides performance enhancements since having different IDs means that MNI endpoints (e.g., subordinate devices of the network) do not need to order read/write responses to the SNI. The mechanism can also be used for ID width reduction and may also simplify system design.

Converting incoming same ID traffic to outgoing traffic with multiple diversified IDs can improve the performance and efficiency of target devices. For example, some memory controllers connected to the output endpoints of the network fabric may perform better if presented with diversified ID requests as opposed to single ID requests.

In addition, target devices may be simplified if an interface of the network interconnect handles reordering responses as part of transforming single ID request traffic to diversified-ID request traffic.

ID diversification in an SNI removes the need for diversification to be performed in each manager device. Diversified IDs are generated for both incoming write requests and incoming read requests based on a configurable and optimized HASH function.

ID diversification may be controlled by one or more configuration registers. The register values are used to provide control over inputs to the hash function that creates the diversified IDs. For example, the width of the outgoing transaction IDs can be increased to minimize hash collisions.

The disclosed mechanism supports ordering rules of protocols such as Arm® AMBA® AXI, in addition to supporting for the more complicated AXI transactions in a pay-as-you-go model.

The use of a diversified ID removes the need for manager network interface (MNI) endpoints to order read/write responses to the SNI. For example, an Arm® Chi MNI (CMNI) does not need a reorder buffer (ROB) to reorder responses.

Single ID requests into an SNI can be split into multi-ID requests that go to MNIs. This can lead to increased end-to-end bandwidth, depending on the characteristics of the subordinate devices connected to the MNIs.

In one embodiment, the mechanism takes advantage of the SNI's reorder buffer. This can be implemented in random access memory (RAM) for better performance and power efficiency.

The diversified IDs may provide performance improvement for downstream targets and can be used for ID width reduction since large incoming transaction ID spaces can be substantially reduced.

In one embodiment, outgoing messages include a tracker table index as metadata. This removes the need for a content addressable memory (CAM) in the SNI for read response processing and a CAM does not need to be searched to see if there is an outstanding request with the same ID/destination ID. The tracker table may be accessed using the index to make sure ordering is preserved and newer requests can't return older data. Alternatively, the SNI may use a CAM.

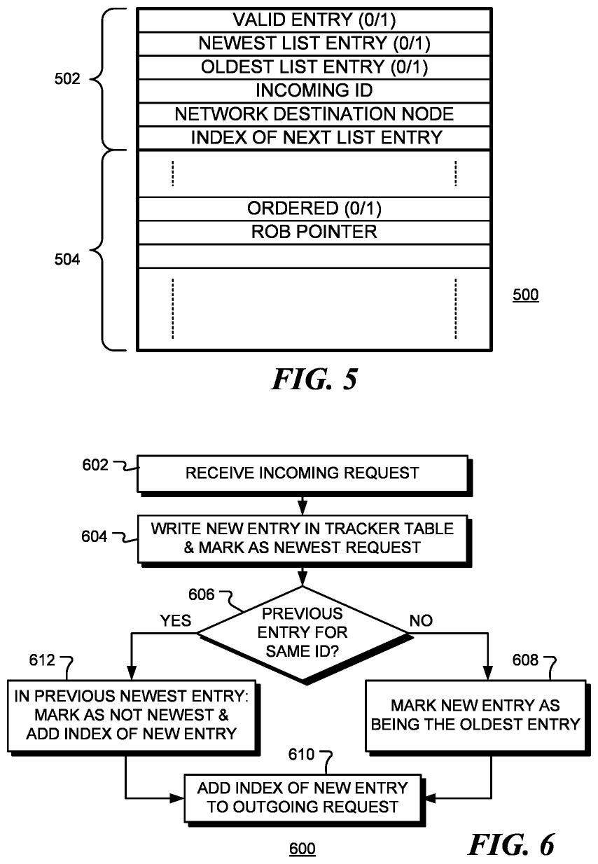

FIG. 5 is a diagrammatic representation of an entry 500 in a tracker table, in accordance with various representative embodiments. The entry includes information 502 used to control the management of the tracker, and information 504 associated with that particular entry. Tracker management information 502 may include, for example, bits indicating:
whether the entry is valid;
when the entry is part of a list, whether this entry is the most recent thing pushed on to the list; and
when the entry is part of a list, whether this entry is the oldest thing on the list.

Tracker management information 502 may also include:
the index of the next entry in the list when the entry is part of a list;
the AXI ID associated with the entry; and
the GT destination node associated with the entry.

Information 504 associated with the entry may include, for example:
information used for requests that perform AXI chunking;
a start-of-message flag;
whether the entry needs to be reordered;
lane count information used when responses are received;
burst split information associated with the entry;
decode error on address lookup for the entry;
trace information associated with the request;
loopback information associated with the request;
AXI unique ID attribute;
system monitor information; and
access protection unit lookup status.

In one embodiment, information 504 associated with the entry may include a ROB pointer that indicates the location of any corresponding response in a reorder buffer (ROB). The ROB pointer may be NULL when no response has been received at the interface. In an alternate embodiment, the corresponding entry in the ROB may store both the response and the index of the corresponding entry in the tracker table. This enables the ROB to be searched based on the index in a response packet.

In general, the SNI includes a mechanism for recording the order in which requests having the same incoming transaction ID are received, together with a mechanism for forwarding responses in the same order.

FIG. 6 is a flow chart of a method 600 of updating a tracker table of an SNI, in accordance with various representative embodiments. At block 602 an incoming request is received at the SNI from a manager device. A new entry, corresponding to the request, is written to the tracker table at block 604. The entry is marked as being the newest request for the incoming transaction ID. If there is no entry in the tracker table with the same incoming transaction ID, as depicted by the negative branch from decision block 606, the new entry is marked as being the oldest entry in the list at block 608. At block 610, the index of the new entry is added to the outgoing request generated from the incoming request. If there are one or more entries in the tracker table with the same incoming transaction ID, as depicted by the positive branch from decision block 606, the entry with the same ID that was previously marked as being the newest is marked as not the newest, and the index of the new entry is added as the index to the next list entry 612. The index of the new entry is added to the outgoing request generated from the incoming request at block 610.

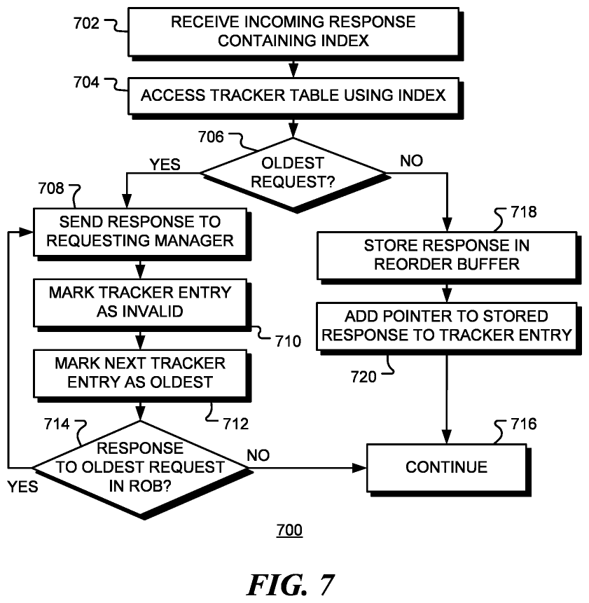

FIG. 7 is a flow chart of a method 700 of processing incoming responses to an SNI, in accordance with various representative embodiments. An incoming response is received at block 702. The response includes the index of an entry in the tracker table for the corresponding request. At block 704, the index is used to access an entry in the tracker table. If the accessed entry indicates that the response relates to the oldest request in an ordered list of requests, as depicted by the positive branch from decision block 706, the response is forwarded to the requesting manager device at block 708, since no older response is outstanding. At block 710, the accessed entry in the tracker table is marked as invalid and, at block 712, the next entry in the list is marked as being the oldest. If the response to this entry has already been received and is stored in the ROB, as depicted by the positive branch from decision block 714, flow returns to block 708 and that response is sent to the manager device. When the oldest response is not in the ROB, as indicated by the negative branch from decision block 714, processing of the response is complete and operation continues at block 716. If the entry indicates that the response does not relate to the oldest request in an ordered list of requests, as depicted by the negative branch from decision block 706, the response is stored in the reorder buffer at block 718. At block 720, a pointer to ROB location is stored in the tracker entry to indicate that the response has been received. In an alternative embodiment, the index from the response is stored in the ROB entry to enable the ROB to be searched. Operation continues at block 716. In this manner, the SNI uses the tracker table and the ROB to enable responses to be forwarded to the manager device in the same order as the corresponding requests were received.

### Support for Edge Cases

The disclosed ID diversification mechanism provides support for edge cases such as atomic write operations, persistence, tag match, two-part responses, exclusive operations, unique ID (as defined in protocols such as the Arm® AXI protocol), device transactions versus normal transactions and ordered-write observations (OWOs). Some of these edge case are discussed below.

Exclusive Operations. Exclusive accesses are used to implement synchronization primitives, such as mutexes and semaphores. An exclusive load request reads a location and tags it. An exclusive store request performs the store if, and only if, the location hasn't been written since the last read using a Load Exclusive. Exclusive requests enable software to read the location of the lock, to see if it's currently free. If free, an attempt is made to gain the lock by writing to the location. The software can check if the write has succeeded, or not.

The hashing operation ensures that an exclusive load and exclusive store to the same address use the same diversified ID, as required in some protocols.

### Atomic Operations.

An atomic operation, such as a read-modify-write sequence, is performed without interference from another manager device. Atomic operations enable a manager device to modify data in a particular region of memory while ensuring that no other manager device can corrupt the data. An atomic write request receives both a read response and a write response. In one embodiment, to avoid putting both the read tracker entry and write tracker entry in the write request header, the SNI is configured to place the read tracker entry in the write header when atomic operations are enabled. The read tracker entry is returned from the target MNI in the read response. In a further embodiment, the SNI performs a CAM lookup for the write response based on the diversified ID and the original incoming transaction ID. Other approaches include:
a. placing both read and write tracker entry indices in write request header,
b. using the original incoming transaction ID instead of the tracker entry, performing a CAM lookup on the write response, since the original incoming transaction ID is in the response ID. Only the read trackerer entry is sent in the write request header.
c. controlling which read tracker entries can handle atomic operations and performing a mini-CAM lookup.

Ordered Write Observations. An interface can be declared as providing Ordered Write Observation if two write transactions, with the same ID, are observed by all other agents in the system in the same order that the transactions are issued. If an interface does not have the Ordered Write Observation property, then the order of observation of writes is only guaranteed for a sequence of writes with the same ID to the same peripheral.

In accordance with an embodiment of present disclosure, exclusive read requests are downgraded to normal read requests to prevent any dependency between read request IDs and subsequent write request IDs. These are required to be the same for corresponding pairs of exclusive reads/exclusive writes.

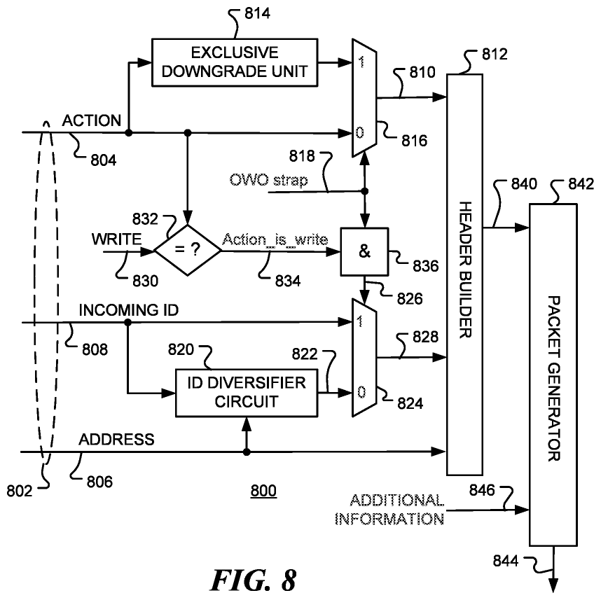

FIG. 8 is a block diagram of a circuit 800 configured to handle Ordered Write Observations (OWOs), in accordance with various representative embodiments. An incoming request on signal channel 802 includes exclusive action 804, address 806 and incoming transaction ID 808. The action 810 sent to header builder 812 is either the incoming exclusive action 804 or an action downgraded in exclusive downgrade unit 814. Action 810 is selected by multiplexer 816 that is controlled by OWO strap signal 818. The downgraded action is selected when OWO strap 818 is enabled, the original exclusive action is selected otherwise. For example, under the Arm® AMBAR AXI protocol, the strap is named “asni_axi.ordered_write_observation_i.” When the strap is tied to “0,” exclusive read and write requests are selected for the outgoing request to be sent to the subordinate network. When the strap is tied to “1,” the downgraded exclusive read and write requests are selected.

Address 806 and ID 808 are used in ID diversifier circuit 820 to generate diversified ID 822. Header builder 812 uses incoming transaction ID 808 when OWO strap 818 is enabled, and the requested action is a write action and uses diversified ID 822 otherwise. The ID is selected by multiplexer 824 that is controlled by logic signal 826 to select ID 828 used by header builder 812. Incoming action 804 is compared with write action 830 in comparator 832 to produce “Action_is_write” logic signal 834. In turn, logic signal 826 is asserted at the output of AND logic unit 836 when logic signal 834 is asserted and OWO strap 818 is enabled. Header builder 812 generates header 840 from selected action 810, selected ID 828 and address 806. Header 840 is passed to packet generator 842, which generates packet 844 from the header and any additional information 846. Packet 844 is sent to the subordinate network.

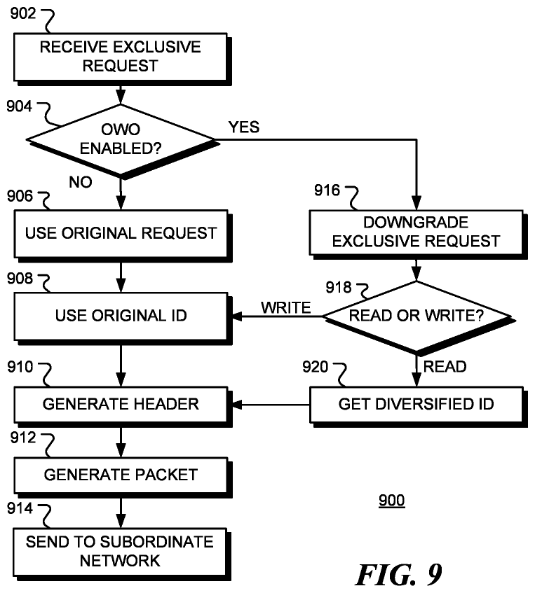

FIG. 9 is a flow chart of a method 900 of handling Ordered Write Observations (OWOs), in accordance with various representative embodiments. An incoming exclusive read or write request is received by an SNI at block 902. When ordered write observations are not enabled, as denoted by the negative branch from decision block 904, the original action is selected at block 906 and the original ID is selected at block 908. A header for the outgoing request is generated at block 910 and the outgoing request packet is generated at block 912. The outgoing packet is sent to the subordinate network at block 914. When ordered write observations are enabled, as denoted by the positive branch from decision block 904, the exclusive request is downgraded at block 916. This allows performance to be maintained for ordered write observations. If the request is an exclusive write request, as depicted by the “WRITE” branch from decision block 918, original ID is selected at block 908 and used in the generation of the header at block 910. If the request is an exclusive read request, as depicted by the “READ” branch from decision block 918, a diversified ID is generated at block 920.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “includes,” “including,” “has,” “having,” or any other variations thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

Reference throughout this document to “one embodiment,” “certain embodiments,” “an embodiment,” “implementation(s),” “aspect(s),” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

The term “or,” as used herein, is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive.

As used herein, the term “configured to,” when applied to an element, means that the element may be designed or constructed to perform a designated function, or that is has the required structure to enable it to be reconfigured or adapted to perform that function.

Numerous details have been set forth to provide an understanding of the embodiments described herein. The embodiments may be practiced without these details. In other instances, well-known methods, procedures, and components have not been described in detail to avoid obscuring the embodiments described. The disclosure is not to be considered as limited to the scope of the embodiments described herein.

Those skilled in the art will recognize that the present disclosure has been described by means of examples. The present disclosure could be implemented using hardware component equivalents such as special purpose hardware and/or dedicated processors which are equivalents to the present disclosure as described and claimed. Similarly, dedicated processors and/or dedicated hard wired logic may be used to construct alternative equivalent embodiments of the present disclosure.

Dedicated or reconfigurable hardware components used to implement the disclosed mechanisms may be described, for example, by instructions of a hardware description language (HDL), such as VHDL, Verilog or RTL (Register Transfer Language), or by a netlist of components and connectivity. The instructions may be at a functional level or a logical level or a combination thereof. The instructions or netlist may be input to an automated design or fabrication process (sometimes referred to as high-level synthesis) that interprets the instructions and creates digital hardware that implements the described functionality or logic.

The HDL instructions or the netlist may be stored on non-transitory computer readable medium such as Electrically Erasable Programmable Read Only Memory (EEPROM); non-volatile memory (NVM); mass storage such as a hard disc drive, floppy disc drive, optical disc drive; optical storage elements, magnetic storage elements, magneto-optical storage elements, flash memory, core memory and/or other equivalent storage technologies without departing from the present disclosure. Such alternative storage devices should be considered equivalents.

Various embodiments described herein are implemented using dedicated hardware, configurable hardware or programmed processors executing programming instructions that are broadly described in flow chart form that can be stored on any suitable electronic storage medium or transmitted over any suitable electronic communication medium. A combination of these elements may be used. Those skilled in the art will appreciate that the processes and mechanisms described above can be implemented in any number of variations without departing from the present disclosure. For example, the order of certain operations carried out can often be varied, additional operations can be added, or operations can be deleted without departing from the present disclosure. Such variations are contemplated and considered equivalent.

The various representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

What is claimed is:

1. A method comprising:
receiving a plurality of incoming requests at an interface of a data processing network from a manager device operably coupled to the interface, the plurality of incoming requests having a common incoming transaction identifier and each incoming request associated with a different address in the data processing network;
for each incoming request of the plurality of incoming requests:
generating an outgoing transaction identifier based on the address and the common incoming transaction identifier; and
sending an outgoing request to a target device in the data processing network, the outgoing request having the outgoing transaction identifier,
where outgoing transaction identifiers differ from one another.

2. The method of claim 1, where generating the outgoing transaction identifier based on the address associated with the incoming request and the common incoming transaction identifier includes:
masking or truncating the address to produce a modified address;
combining the modified address and the common incoming transaction identifier to produce a hash argument; and
generating a hash value of the hash argument as the outgoing transaction identifier.

3. The method of claim 2, where the address has an address bit-width and where combining the modified address and the common incoming transaction identifier to form a hash argument includes:
expanding the common incoming transaction identifier to the bit-width of the modified address; and
generating the hash argument as a bitwise logical combination of the expanded common incoming transaction identifier and the modified address.

4. The method of claim 1, where the plurality of incoming requests are ordered, further comprising:
receiving responses to the outgoing requests at the interface; and
forwarding the responses to the master device in the same order as the incoming requests were received.

5. The method of claim 1, further comprising:
for each incoming request of the plurality of incoming requests:
generating an entry for the incoming request at a location in a tracker table, the location having an index;
including the tracker table index in the outgoing request corresponding to the incoming request;
receiving a response to the outgoing request, the response including the tracker table index of the output request;
accessing an entry to the tracker table at a location in accordance with the tracker table index included in the response; and
processing the response in accordance with the accessed tracker table entry.

6. The method of claim 5, where processing the response in accordance with the accessed tracker table entry includes ordering a plurality of responses in accordance with an order of the plurality of incoming requests.

7. The method of claim 1, where generating an outgoing transaction identifier for each incoming request includes:
generating a first outgoing transaction identifier for a first incoming request of the plurality of incoming requests for an exclusive load operation from a first address; and
generating a second outgoing transaction identifier for a second incoming request of the plurality of incoming requests for an exclusive store operation to a second address,
where the first and second outgoing transaction identifiers are the same when the first and second addresses are the same.

8. The method of claim 1, further comprising:
converting the incoming request from a first protocol to provide the outgoing request in a second protocol.

9. The method of claim 1, further comprising:
downgrading an exclusive read request when ordered write observations are enabled; and
generating the outgoing transaction identifier based on the address and the common incoming transaction identifier when ordered write observations are enabled.

10. The method of claim 9, further comprising:
downgrading exclusive write requests when ordered write observations are enabled,
including the incoming transaction identifier in the outgoing transaction identifier when ordered write observations are enabled; and
generating the outgoing transaction identifier based on the address and the common incoming transaction identifier when ordered write observations are not enabled.

11. A network interface configured to:
receive a plurality of incoming requests from a manager device of a data processing network, the plurality of incoming requests having a common incoming transaction identifier and each incoming request associated with a different address in the data processing network; and
for each incoming request of the plurality of incoming requests:
generate, in an identification (ID) diversifier circuit of the interface, an outgoing transaction identifier based on the address and the common incoming transaction identifier; and
send an outgoing request to a target device in the data processing network, the outgoing request having the outgoing transaction identifier,
where the outgoing transaction identifiers generated differ from one another.

12. The network interface of claim 11, comprising:
a logic circuit configured to perform a bitwise combination of the address and the incoming transaction identifier, producing a hash argument; and
a hash circuit configured to generate a hash of the hash argument as at least a portion of an outgoing transaction identifier.

13. The network interface of claim 11, comprising:
an address modification circuit configured to mask or truncate the address to provide a modified address with n-bits, where n is an integer;
an expansion circuit configured to expand the incoming transaction identifier to n-bits to provide an expanded identifier;
a logic circuit configured to perform a bitwise combination of the modified address and the expanded identifier, producing a hash argument; and
a hash circuit configured to generate a hash of the hash argument as at least a portion of an outgoing transaction identifier.

14. The network interface of claim 11, further comprising a tracker table for recording an order of incoming requests.

15. The network interface of claim 11, further comprising a re-order buffer (ROB) for storing out-of-order responses to outgoing requests.

16. The network interface of claim 11, comprising configuration registers where operation of the ID diversifier circuit is controlled by values stored in the configuration registers.

17. The network interface of claim 11, further comprising:
an exclusive downgrade unit configured to downgrade an exclusive read request when ordered write observations are enabled,
where the network interface is further configured to generate the outgoing transaction identifier using the identification (ID) diversifier circuit when ordered write observations are enabled.

18. The network interface of claim 17, where the exclusive downgrade unit is further configured to downgrading exclusive write requests when ordered write observations are enabled, the network interface further configured to:
generate the outgoing transaction identifier using the identification (ID) diversifier circuit when ordered write observations are not enabled; and
use the incoming transaction identifier as the outgoing transaction identifier when ordered write observations are enabled.

19. A non-transitory computer-readable medium to store computer-readable code for fabrication of a network interface configured to:
receive a plurality of incoming requests from a manager device of a data processing network, the plurality of incoming requests having a common incoming transaction identifier and each incoming request associated with a different address in the data processing network; and
for each incoming request of the plurality of incoming requests:
generate, in an identification (ID) diversifier circuit of the interface, an outgoing transaction identifier based on the address and the common incoming transaction identifier; and
send an outgoing request to a target device in the data processing network, the outgoing request having the outgoing transaction identifier,
where the outgoing transaction identifiers differ from one another.

20. The non-transitory computer-readable medium of claim 19, where the computer readable code includes code for fabrication of the ID diversifier circuit, the code for fabrication of the ID diversifier circuit being configurable to adjust a size of the outgoing transaction identifiers in a fabricated network interface.
